(19) United States
(12) Patent Application Publication
(10) Pub. No.: US 2008/0052644 A1
(43) Pub. Date: Feb. 28, 2008

(54) STRING MATCHING ENGINE FOR ARBITRARY LENGTH STRINGS

(75) Inventors: Pranav Ashar, Belle Mead, NJ (US); Jitendra Kulkarni, San Jose, CA (US); Ashwini Choudhary, San Jose, CA (US)

Correspondence Address: BEYER WEAVER LLP, P.O. BOX 70250, OAKLAND, CA, 94612-0250, US

(73) Assignee: NetFortis, Inc., Mountain View, CA (US)

(21) Appl. No.: 11/558,061

(22) Filed: Nov. 9, 2006

Related U.S. Application Data
(60) Provisional application No. 60/840,168, filed on Aug. 25, 2006.

(51) Int. Cl. G06F 17/50

(52) U.S. Cl. 716/2; 716/4

(57) ABSTRACT

An efficient finite state machine implementation of a string matching that relies upon a Content Addressable Memory (CAM) or a CAM-equivalent collision-free hash-based lookup architecture with zero false positives used as a method for implementing large FSMs in hardware using a collision-free hash-based look up scheme with low average case bandwidth and power requirements that overcomes prior art limitations by providing the ability to match an anchored or unanchored input stream against a large dictionary of long and arbitrary length strings at line speed. It should be noted that in the context of the described embodiments, a string could take many forms, such as a set of characters, bits, numbers or any combination thereof.

### CROSS REFERENCE TO RELATED APPLICATIONS

This patent application takes priority under 35 U.S.C. 119(e) to (i) U.S. Provisional Patent Application No. 60/840,168, filed on Aug. 25, 2006 (Attorney Docket No. NETFP001P) entitled “STRING MATCHING ENGINE” by Choudhary et al. This application is also related to (i) co-pending application entitled, “STRING MATCHING ENGINE” by Choudhary et al (Attorney Docket No. NETFP001) having application Ser. No. 11/550,320 and filed Oct. 17, 2006 and (ii), co-pending application entitled, “REGULAR EXPRESSION MATCHING ENGINE” by Ashar et al (Attorney Docket No. NETFP003) having application Ser. No. ______ and filed ______ each of which are incorporated by reference in their entirety for all purposes.

### BACKGROUND

1. Field of the Invention

The invention relates to string matching engine technology

2. Description of Related Art

A Finite State Machine (FSM) is the nominal hardware structure used to implement control flow. Many other important algorithms can also be modeled as FSM traversal. For example, a regular expression or a collection of strings can be modeled as an FSM, and regular expression matching or string matching can be formulated as FSM traversal. A state machine specification consists of states and transitions between them. A transition may be autonomous or triggered by an external input. A state machine may have outputs defined as a function of the state or of the combination of the state and input value. A state machine may also have accepting states corresponding to termination conditions for the algorithm being implemented on the state machine.

As the state machine grows in size (as the number of states and transitions between them grows), the complexity of the next state and output logic representation grows very rapidly. This is the case even though the number of bits required to encode the states is only log of the number of states (for example, a million states would require about 20 encoding bits). In practice, it is very difficult to use conventional combinational logic implementations of large state machines in a manner that meets timing, power and area constraints. For example, when implementing FSM-based algorithms for string or regular expression matching, the number of states and state transitions can be in the millions. Implementation of an FSM of this size in the conventional manner using combinational logic would lead to a very slow operational speed, very high power consumption and a large area requirement.

A conventional combinational logic and state element implementation of an FSM is also not desirable when the FSM is required to be configurable. On-the-fly logic configurability requires special technology (for example Field Programmable Gate Array) that tends to be suboptimal relative to conventional ASIC technology. Also, small changes in the FSM can entail substantial changes in the logic implementation, leading to impractical reconfiguration times.

Finite-automaton based methods model dictionary strings as a state machine, and the string-matching problem is modeled as one of traversing the state machine to an accepting state. The Aho-Corasick algorithm optimizes the state machine for a multiplicity of dictionary strings and allows finding all possible matches of the input stream against the dictionary strings. The complexity of the Aho-Corasick algorithm is O(n) for matching against the entire dictionary, where n is the number of characters in the input stream. The algorithms have the limitation that the state machine modeling the dictionary strings tends to grow rather rapidly. Implementing such large state machines in software or conventional logic based hardware results in very low performance and very high code or area/power overheads. As a result, practical implementations tend to match against small sections of the dictionary at a time, increasing the complexity from the ideal O(n). Logic implementation of the state machines also makes it very hard to accommodate dictionary updates.

Accordingly, what is needed is a system and method to address the above-identified problems. The present invention addresses such a need.

### SUMMARY OF DESCRIBED EMBODIMENTS

Broadly speaking, the invention relates to an efficient finite state machine implementation of a string matching that relies upon a Content Addressable Memory (CAM) or a CAM-equivalent collision-free hash-based lookup architecture with zero false positives used as a method for implementing large FSMs in hardware with low average case bandwidth and power requirements that overcomes prior art limitations by providing the ability to match an anchored or unanchored input stream against a large dictionary of long and arbitrary length strings at line speed. It should be noted that in the context of the described embodiments, a string could take many forms, such as a set of characters, bits, numbers or any combination thereof.

In one embodiment, the arbitrary length string matching problem is formulated as a state machine traversal wherein the dictionary is represented as an FSM in which a state represents the past history of input characters received, a transition from one state to the next is predicated on the value of the current input character of the string, and the FSM is implemented as a CAM. The CAM stores the rows of the state transition table of the FSM such that each row contains the input, current state and corresponding next state for a transition. Some states of the FSM are marked accepting states such that when one of these states is reached, a specific string is known to have been matched. The accepting state information is also stored with the state transition rows in the CAM. The arbitrary length string being matched is streamed in to the lookup architecture one or more characters (the input unit) at a time. In general, the matching is performed by looking up the concatenation of the current input unit and the current state in the CAM to determine if a row with this combination is present in the FSM transition table. If such a row is detected, the corresponding next state is determined as part of the lookup. The traversal is further performed with the just determined next state becoming the next state and using the next input unit from the string if such an input unit is available. If no more input units are available, the process is said to have completed. Also, during the CAM lookup, it is determined if the next state is an accepting state. If it is an accepting state, the string match signal is issued, otherwise it is not issued. If during the CAM lookup, no entry is found corresponding to the current input unit and current state, the default transition from the current state, as specified in the FSM, is performed, the match signal is not issued, and traversal is further performed as indicated above.

In a refinement of the above embodiment, the transition table for the dictionary FSM is implemented using the CAM-equivalent zero-false positive lookup architecture described here. The concatenation of the current input unit and current state is k-way hashed into addresses in a first memory, and a subset of the k addresses are identified that contain an address into a second memory that stores the FSM transition table. The lookup is deemed successful when the one of the addresses identified in the second memory contains the same input unit and state pair as being currently applied. Apart from this refinement in the lookup scheme, the FSM traversal and arbitrary length string matching is performed as above.

In another embodiment, computer program product executable by a processor for implementing an arbitrary finite state machine (FSM) is described. The computer program product includes computer code for performing an FSM transition by looking up a concatenation of the input and current state as an input look up value in the CAM or CAM-equivalent data structure, transitioning to the next state stored in the row and performing actions associated with the transition attributes stored in the row if the concatenation of the input and current state is found in the row, or performing a default transition from the current state if the concatenation of the input and current state is not found in the row, wherein the FSM is configured as either a content addressable memory (CAM) or CAM-equivalent data structure each having transition edges stored as rows, wherein each row includes the current state, input and next state, and any other attribute associated with the transition.

In still other embodiments, a method and computer program product for arbitrary length string matching using a string dictionary represented as a finite state machine in which a state represents the past history of a received input string unit. The method is performed by and the computer program product includes computer code executable by a processor for receiving an arbitrary length string formed of a plurality of string units, selecting a number of the plurality of string units as input string units, concatenating the input string unit with a current state of the FSM as an input value, detecting if a row in a state transition table of the FSM includes the input value, determining a corresponding next state if a row that includes the input value is detected, and transitioning to the next state.

Other aspects and advantages of the invention will become apparent from the following detailed description taken in conjunction with the accompanying drawings.

### DESCRIPTION OF DRAWINGS

FIG. 1 shows an example of a personal communication device in accordance with an embodiment of the invention.

FIG. 2 shows a string-matching engine that is well suited for matching strings having an arbitrary length.

FIG. 3 shows an implementation of a string dictionary using a CAM equivalent architecture.

FIGS. 4-7 illustrate particular embodiments used in the CAM equivalent architecture.

FIGS. 8A and 8B show a flowchart detailing a process for matching an input string in accordance with an embodiment of the invention.

### DETAILED DESCRIPTION OF SELECTED EMBODIMENTS

Reference will now be made in detail to a particular embodiment of the invention an example of which is illustrated in the accompanying drawings. While the invention will be described in conjunction with the particular embodiment, it will be understood that it is not intended to limit the invention to the described embodiment. To the contrary, it is intended to cover alternatives, modifications, and equivalents as may be included within the spirit and scope of the invention as defined by the appended claims.

In the described embodiments, either a content addressable memory (CAM) or a CAM-equivalent collision-free hash-based lookup architecture with zero false positives is used for implementing large finite state machines (FSM) in hardware. In this way, state transitions and outputs are computed with a predictable latency consisting of a fixed and small number of memory lookups. Furthermore, using embedded memory, it is possible to optimize the memory bank architecture to suit the bit-widths and other lookup requirements of the FSM. In one embodiment, the arbitrary length string matching problem is formulated as a state machine traversal wherein the dictionary is represented as an FSM in which a state represents the past history of input characters received, a transition from one state to the next is predicated on the value of the current input character of the string, and the FSM is implemented as a CAM. The CAM stores the rows of the state transition table of the FSM such that each row contains the input, current state and corresponding next state for a transition.

Some states of the FSM are marked accepting states such that when one of these states is reached, a specific string is known to have been matched. The accepting state information is also stored with the state transition rows in the CAM. The arbitrary length string being matched is streamed in to the lookup architecture one or more input units (a character, for example) at a time. In general, the matching is performed by looking up the concatenation of the current input unit and the current state in the CAM to determine if a row with this combination is present in the FSM transition table. If such a row is detected, the corresponding next state is determined as part of the lookup. The traversal is further performed with the just determined next state becoming the next state and using the next input unit from the string if such an input unit is available. If an additional input unit is not available, the process is said to have completed. Also, during the CAM lookup, it is determined if the next state is an accepting state. If it is an accepting state, the string match signal is issued, otherwise it is not issued. If during the CAM lookup, no entry is found corresponding to the current input unit and current state, the default transition from the current state, as specified in the FSM, is performed, the match signal is not issued, and traversal is further performed as indicated above.

In a refinement of the above embodiment, the transition table for the dictionary FSM is implemented using the CAM-equivalent zero-false positive lookup architecture described herein. The concatenation of the current input unit and current state is k-way hashed into k addresses in a first memory arranged, for example, in rows and columns where each of the rows has a first data field that includes a Bloom bit used to identify those incoming strings that cannot be stored in the string dictionary. Each of the rows also includes a second data field that includes a unique bit that is used to determine a sub-set of the k hash locations that hold useful data (thereby eliminating false positives inherent with Bloom filters). Each of the rows also includes a third data field that includes information that identifies an address in a second memory that stores the FSM transition table that is used to determine if the incoming string is stored in the string dictionary or not. In the case where the incoming string is stored in the string dictionary, the string-matching engine issues a match signal; otherwise a no match signal is issued.

In the described refinement, a subset of the k addresses is identified that contain information that identifies an address in a second memory that stores the FSM transition table. The lookup is deemed successful when the one of the subset of the k addresses identified in the second memory contains the same input unit and state pair as being currently applied. Apart from this refinement in the lookup scheme, the subsequent FSM traversal and arbitrary length string matching is performed as above.

It should be noted that if the FSM is implemented as a true CAM, the string lookup in the direct scheme or the next state lookup in the FSM based scheme does not require a k-way hash since all that is required is to lookup the concatenation of the input and current state in the CAM. K-way hashing and associated filtering is only required when using the CAM equivalent architecture.

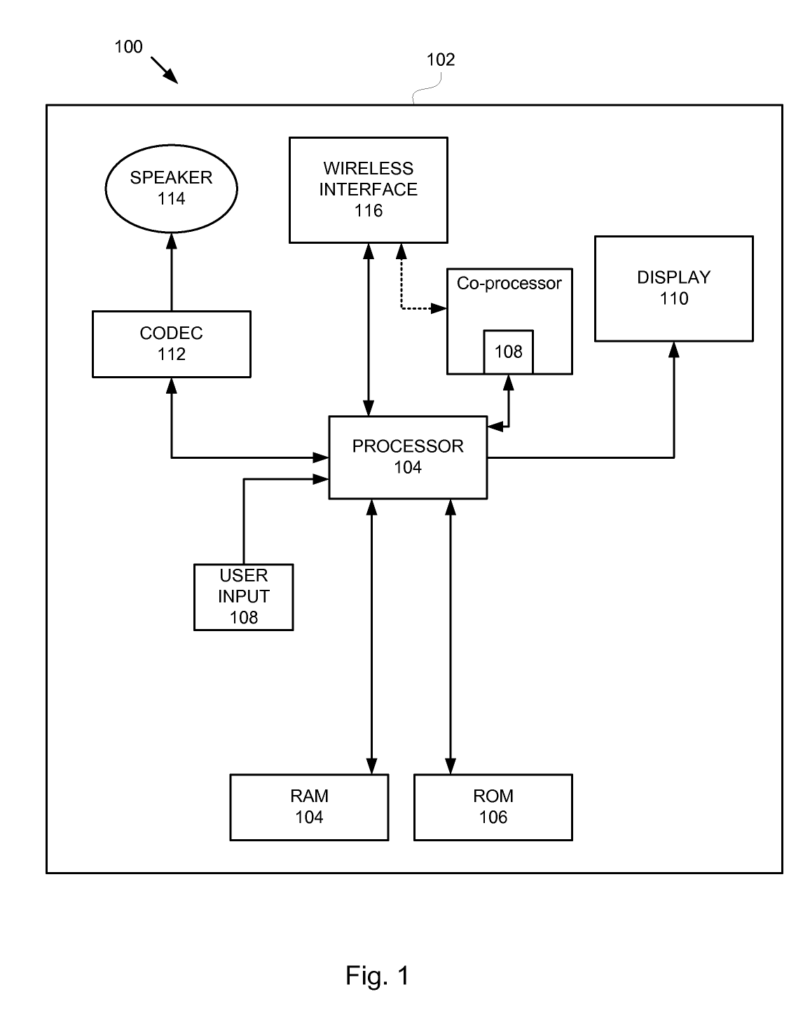

In this way, the described string matching engine implemented using a FSM provides for efficient string matching using a low memory collision-free hash-based look up scheme with low average case bandwidth and power requirements that overcomes prior art limitations by providing the ability to match against a large dictionary of long and arbitrary length strings at line speed. The described embodiments will now be described in terms of a string matching engine, system, and method useful in a number of applications where memory and computing resources are at a premium or, high performance is desired. Such applications are typically found in portable devices such as personal communication devices 100 (shown in FIG. 1) that include cell phones, PDAs, and other devices (referred to as thin client devices) having a comparatively small on board memory and limited processing capabilities that can be part of a communication network.

The described string matching engine can be deployed as a macro program executed by a central processing unit (CPU) or included in a co-processor having its own memory and computing resources arranged to filter any incoming traffic for strings that have been identified as potential malware (i.e., a computer virus). In this way, malware detection can be off-loaded from the CPU thereby freeing up computing and memory resources otherwise required for detection of malware that would have the potential to severely disrupt the operation of the personal communication device 100. In some cases, the strings are stored in a string dictionary and used by the string machine engine to detect such malware are supplied and periodically updated by a third party on either a subscription basis or as part of a service contract between a user and a service provider.

FIG. 1 shows a personal communication device 100 as a pocket sized cell phone 100 that provides the standard voice function of a telephone in addition to many additional services such as SMS for text messaging packet switching for access to the Internet and MMS for sending and receiving photos and video. The cell phone 100 is contained in a housing 102 that supports a processor 104 and a co-processor 106 (coupled to the processor 104) that includes a string-matching engine 108. (in some embodiments, the string-matching engine 108 can take the form of a macro or a program that is incorporated into the processor 104.) It should be noted that the described string-matching engine 108 could be used in any application whereby a low power, efficient (in both memory and computing resources) string-matching protocol is deemed appropriate. The processor 104 pertains to a microprocessor or controller for controlling the overall operation of the cell phone 100. The cell phone 100 further includes a RAM 110 that provides volatile data storage such as currently called phone numbers, ring tones, etc. and a Read-Only Memory (ROM) 112 arranged to store programs, utilities or processes to be executed in a non-volatile manner.

The cell phone 100 also includes a user input device 114 that allows a user to interact with the cell phone 100. For example, the user input device 114 can take a variety of forms, such as a button, keypad, dial, etc. Still further, the cell phone 100 includes a display 116 (screen display) that can be controlled by the processor 104 to display information to the user. A data bus can facilitate data transfer between at least the ROM 112, RAM 110, the processor 104, and a CODEC 118 that produces analog output signals for an audio output device 120 (such as a speaker). The speaker 120 can be a speaker internal to the cell phone 100 or external to the cell phone 100. For example, headphones or earphones that connect to the cell phone 100 would be considered an external speaker. A wireless interface 122 operates to receive information from the processor 104 that opens a channel (either voice or data) for transmission and reception typically using RF carrier waves.

During operation, the wireless interface 122 receives an RF transmission carrying an incoming data stream 124 in the form of data packets 126. Copies of the data packets are made and in some cases undergo additional processing prior to being forwarded to the co-processor 104 for examination by the string-matching engine 108 for possible inclusion of strings associated with known computer malware. In the described embodiment, the group of stored strings (referred to as a string dictionary) used by the string matching engine 108 are provided by a third party and are periodically updated with new strings in order to detect new computer malware. It should be noted that the inputs to the string-matching engine do not need to be derived solely from traffic. For example, inputs to the string-matching engine can take the form of files already resident in the cell phone memory (RAM 110, ROM 112).

The string-matching engine 108 will provide a match flag 128 in those situations where the incoming data stream 124 includes a string 130 that matches one of the entries in the string dictionary. The match flag 128 will notify the CPU 104 that the cell phone 100 has been exposed to potentially harmful computer malware and appropriate prophylactic measures must be taken. These measures can include malware sequestration, inoculation, quarantine, etc. provided by a security protocol.

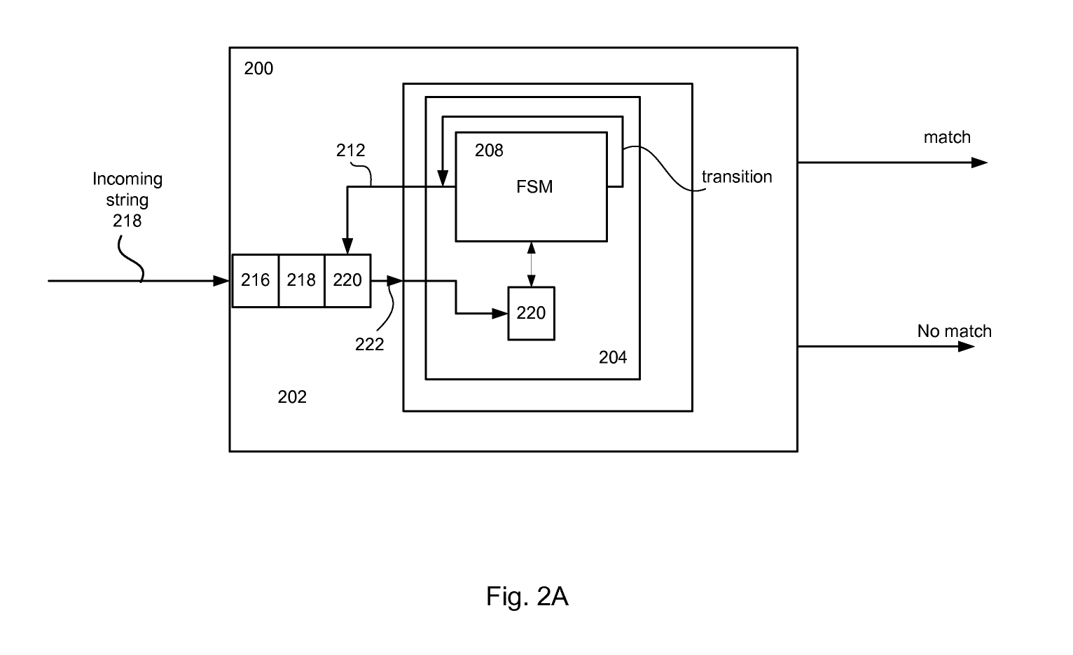

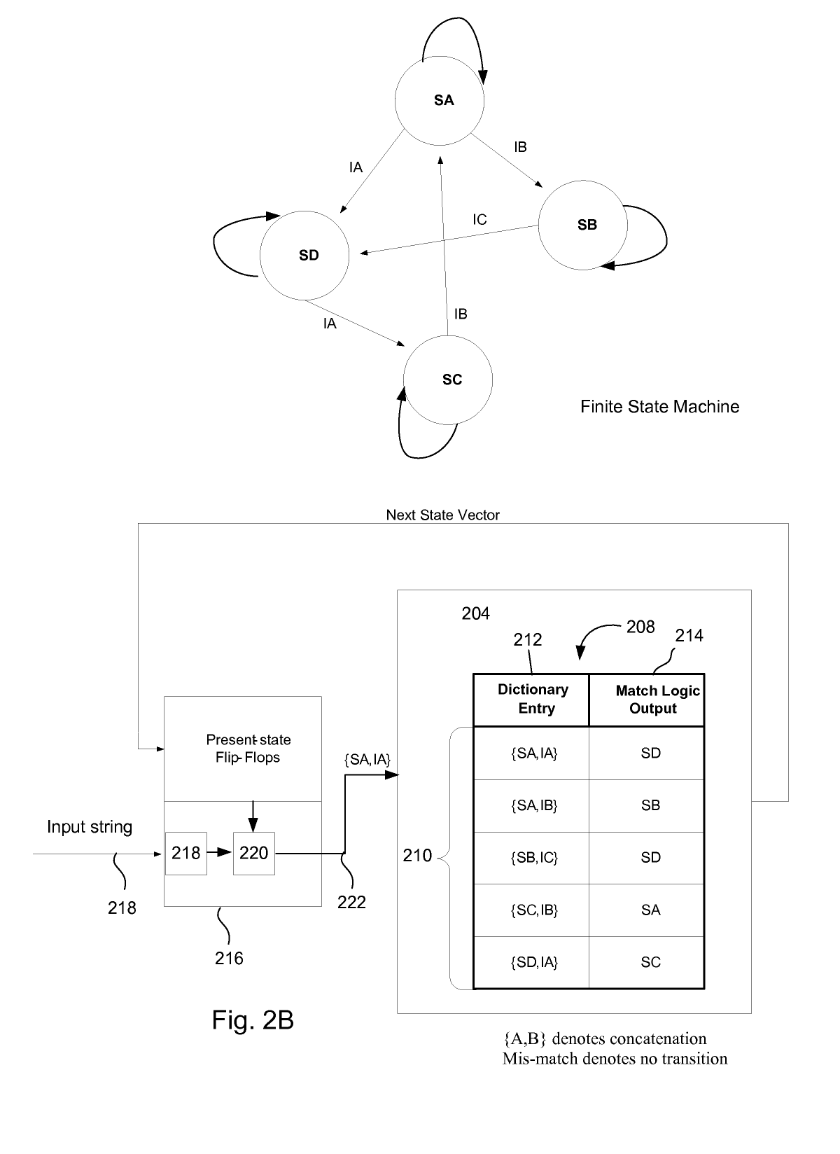

FIG. 2 shows a string-matching engine 200 (one embodiment of the string-matching engine 108) that well suited for matching strings having an arbitrary length having a string dictionary 202 implemented as a FSM 204 stored in a CAM memory device 206. The FSM 204 is configured to include a FSM transition table 208 having a number of transition rows 210 that store data that includes a FSM current state value 212 and transition instructions 214. It should be noted that the transition table 208 also stores information about whether the next state in a transition is an accepting state. The string matching engine 200 also includes an input string receiving unit 216 arranged to receive any number of incoming strings 218 (each formed of a plurality of string units) having arbitrary length and a string unit selector 219 arranged to select and forward a number of the plurality of input string units to a concatenator 220 that concatenates the received input string unit with the current state value 212 received from the FSM 204 to form an input value 222. The input value 222 is then forwarded to a compare unit 224 in the CAM memory device 206 that determines if a row with the input value 222 is present in the FSM transition table 208. Based upon the comparison, a number of different actions can result depending upon the traversal instructions associated with the row having the current state. For example, in one implementation, when the input value does not match any of the rows in the transition table 208, a default transition signal is issued that instructs the processor to execute a default transition from the current state that, in some embodiments, also results in the issuance of a no match signal.

On the other hand, if a row in the transition table 208 having the input value 222 is detected, then the processor determines a corresponding next state and if the next state is determined to be an accepting state, then the processor instructs the string-matching engine 200 to issue a match signal. If, however, the next state is not an accepting state, then the processor determines if there is a next input unit, and if so, then the matching process is continued as long as the input character stream is not exhausted. In this manner, anchored or unanchored string matching is performed for the input stream. It should be noted that this approach works well in situations where the number of state plus input combinations required for modeling all the FSM transitions can be accommodated in the CAM/CAM-equivalent dictionary.

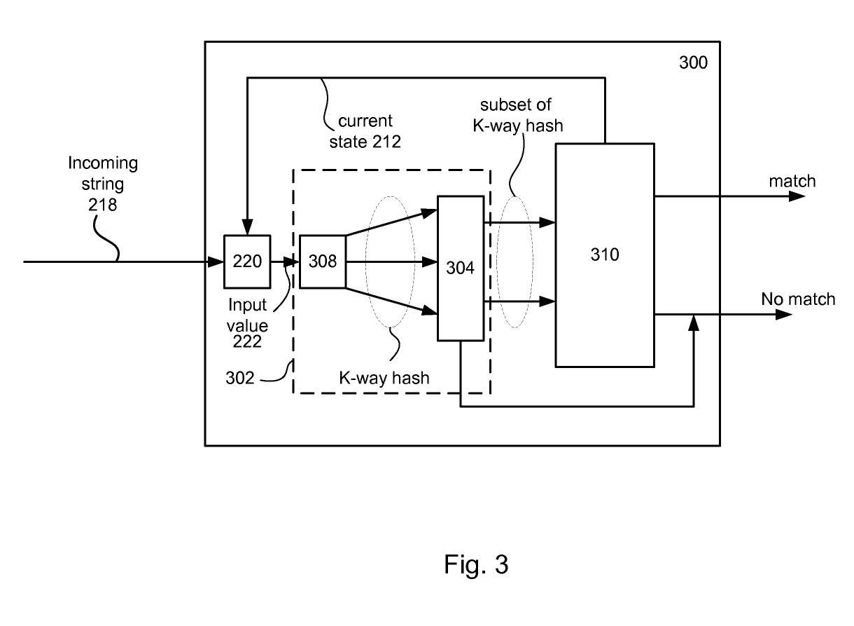

Alternatively, if the string dictionary is configured using a CAM equivalent architecture shown in FIG. 3, then the string-matching engine 300 includes a primary string filter 302 having a hash look up table 304. In this case, a k-way hashing unit 308 k-way hashes the input value 222 into k addresses in the hash look up table 304. A subset of the k addresses is then identified that contain information that identifies an address(es) in the CAM equivalent 310. The lookup is determined to be successful when the one of the subset of the k addresses identified in the CAM contains the input value resulting in the issuance of the match signal. It should be noted that in the example shown, the primary hash lookup table 304 includes Bloom bits that provide an immediate indication that the input value 222 (as described above being a combination of state and input in the context) is not included in the string dictionary resulting in, for example, a default transition thereby eliminating any possibility of a false negative.

In a particularly useful embodiment, the addition of a new string to the string dictionary entails modifications to the dictionary FSM including some modification of the transition structure involving addition and deletion of transition edges. The addition/deletions reflected in the primary hash lookup table are the changes in the edge transitions rather than the actual strings.

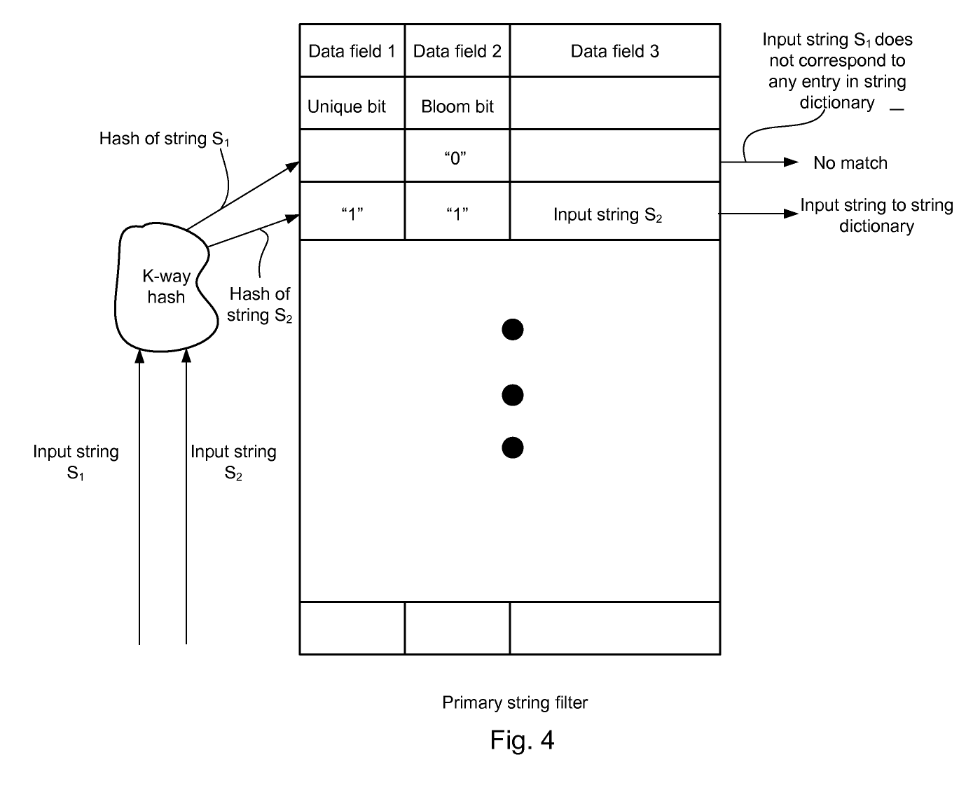

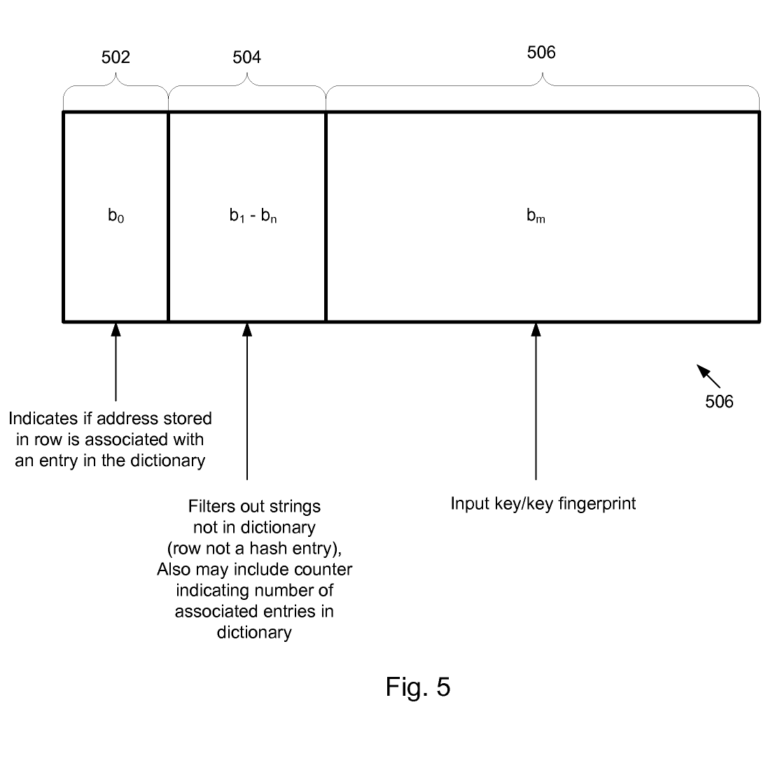

FIGS. 4-7 illustrate particular embodiments used in the CAM equivalent architecture 300. Accordingly, FIG. 4 shows an embodiment of the primary string filter configured as a hash look up table 400 in the form of memory space arranged as m rows where each row is capable of storing n data bits. FIG. 5 illustrates a representative memory row 500 having a first field 502 with a bit location b₀ (referred to as a unique bit) that is used to mark the use of that particular row address as including information considered relevant. A second field 504 includes a second bit (or collection of bits (b₁ to bₓ)) that may be used to indicate if the memory row 500 was hashed to by any other element of the string dictionary and, optionally, counter bits that could be counted up to the maximum value whenever an entry in the string dictionary points to this particular row address thereby enabling the deletion of dictionary entries in constant time. A third field 506 includes a set of bits (bₓ₊₁ to b_{x+w}) that stores the input key (or key-fingerprint) and any data associated with the key.

Referring back to FIG. 4, during lookup, if any of the collection of bits {bₓ . . . b₁} is 0, the associated input is definitely not a member of the string dictionary (thereby acting as a first filter along the lines of the Bloom filter and henceforth is referred to as a Bloom bit for simplicity). On the other hand, if the Bloom bit is not 0, then the associated input string may be a string dictionary entry and the string matching engine 200 identifies the subset of addresses (out of the k addresses generated by the k hash functions) for which b₀=1. This requires that only k bits are fetched from the primary lookup table initially, followed by a fetch of b_{w} bits (bₓ₊₁ . . . b_{x+w}) of the addresses at which b₀ is 1. The corresponding input key/key-fingerprints are then compared against the key/key-fingerprint stored in the string dictionary represented as transitions in the FSM. If a match is found, the input key is a member of the string dictionary, else it is not and the default transition is taken.

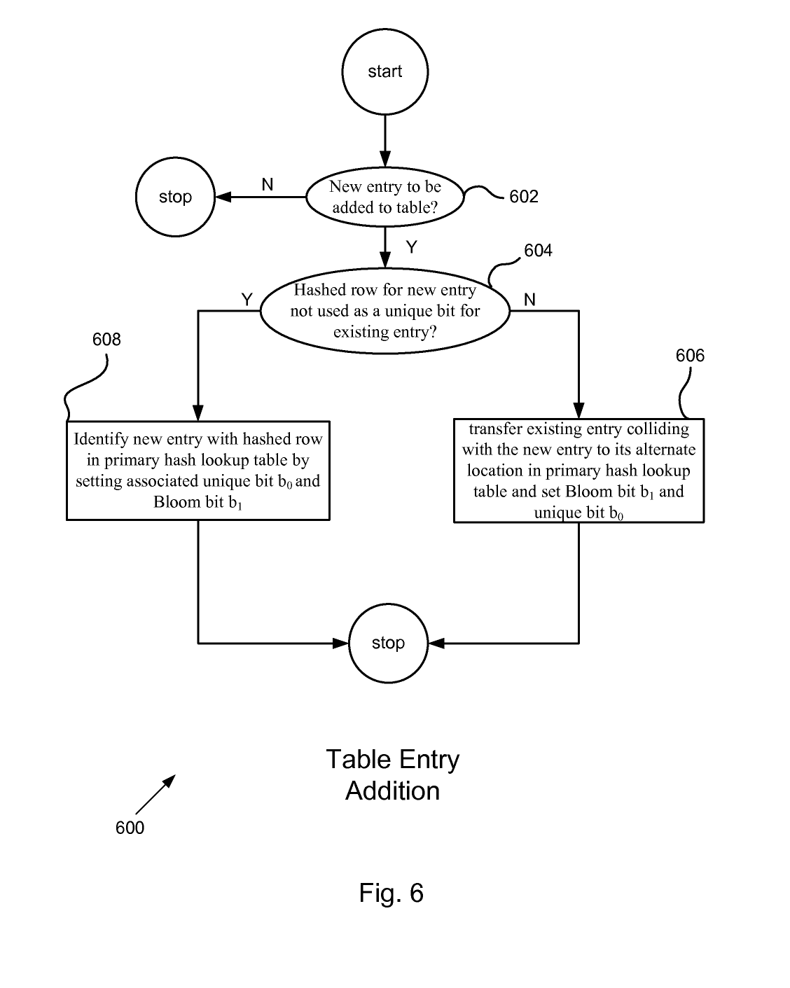

FIG. 6 illustrates a process 600 for updating the primary hash lookup table when a new entry is added to the string dictionary in accordance with an embodiment of the invention. Accordingly, the process 600 begins at 602 by determining if a new dictionary string has been added to the string dictionary. If a new dictionary string has been added, then at 604 if a hashed row for the new entry is not used as a unique bit for the existing entry, then the new entry is identified with the hashed row in the hash lookup table and the associated Bloom bit b₁ and unique bit b₀ are set at 606. Otherwise, at 608, the existing entry is transferred to an alternate location in the primary hash lookup table and the associated Bloom bit b₁ and unique bit b₀ are set and the new entry replaces the now transferred entry at 610. It should be noted that the addition mechanism above has the advantage that the addition of transition edges to the FSM is not position dependent and hence can simply be appended to or located at any convenient location in the memory without location restrictions. In a conventional FSM deployment, association of edge to the state it originates from is positional. So adding an entry may require relocating entries at population time, or maintaining a linked list, which is expensive during matching.

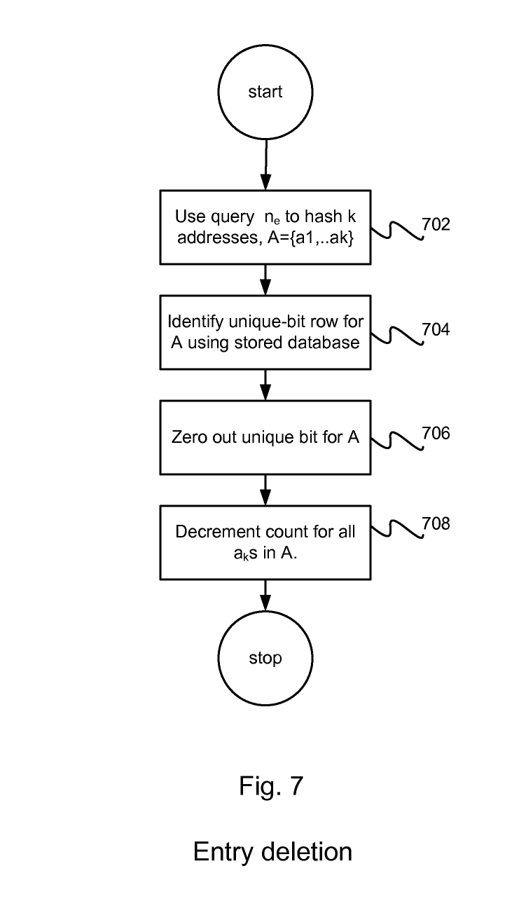

FIG. 7 shows a flowchart detailing a process 700 for deleting an entry in accordance with an embodiment of the invention. The process 700 begins at 702 by using a query nₑ to hash A addresses {a₁ . . . aₖ) followed at 704 by using a stored database to identify the unique bit row for A. At 706, the unique bit for A is then zeroed out and at 708 the counter for all member of A are decremented. In addition, it is also possible to use more bits such that the combination of these bits in the hashed addresses provides further identification of the absence of a match.

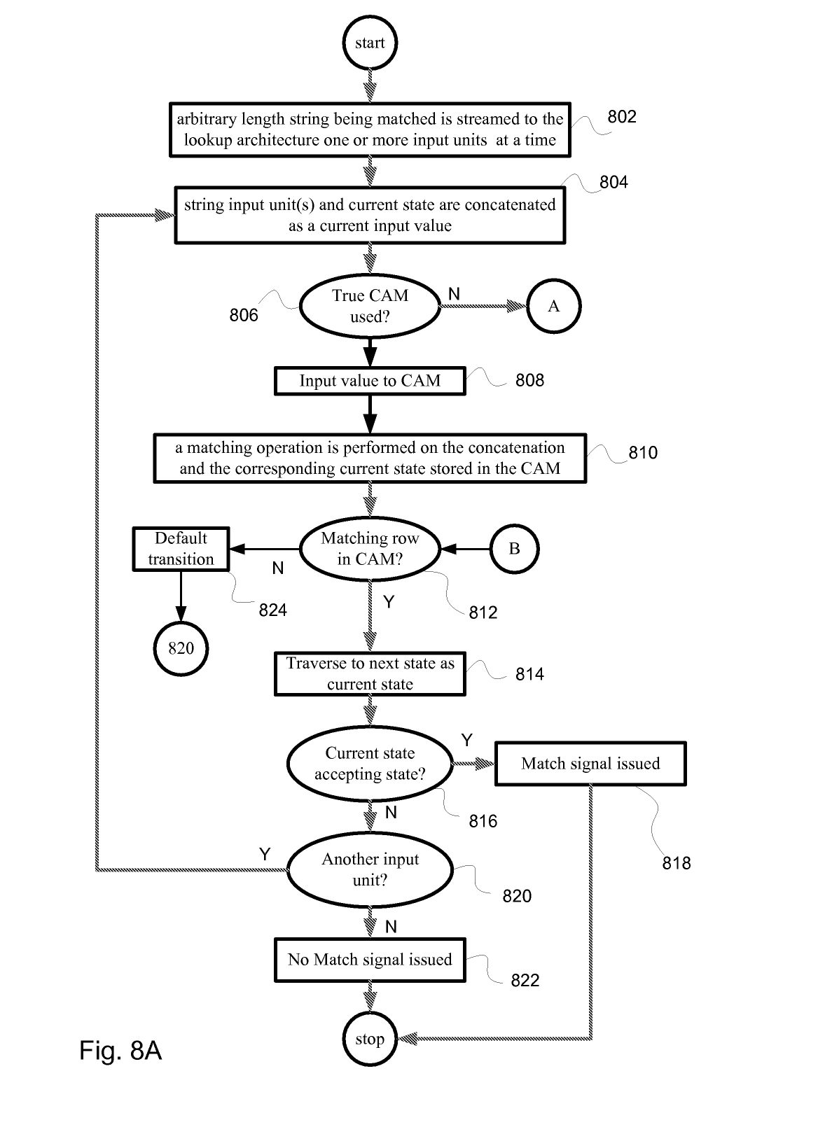

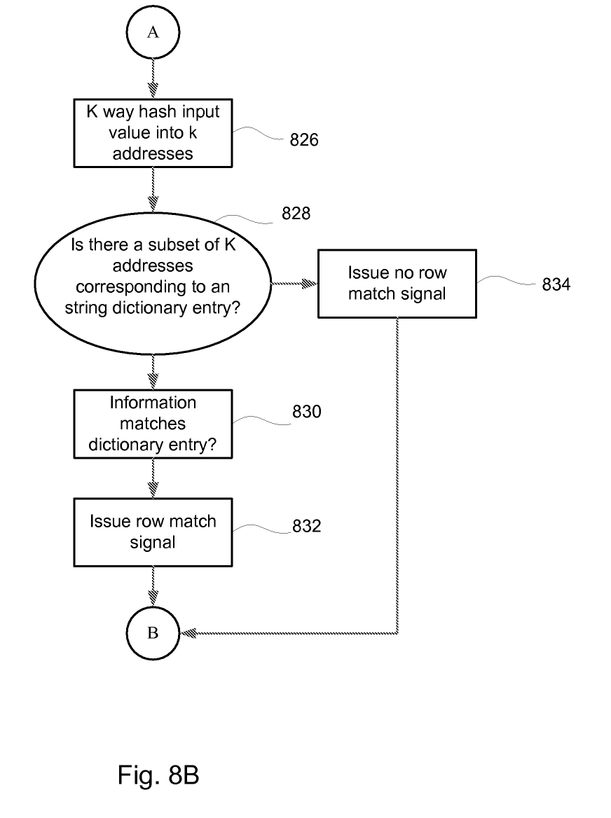

FIGS. 8A-8B shows a flowchart detailing a process 800 carried out by a string-matching engine (one embodiment of the string-matching engine 108) where the string dictionary is represented as an FSM (that can be configured using a CAM or CAM equivalent architecture) in which a state represents the past history of input characters received and a transition from one state to the next is predicated on the value of the current input character of the string. At 802, the arbitrary length string being matched is streamed in to the lookup architecture one or more input units (a character, for example) at a time. At 804, a string input unit and current state is concatenated as a current input value. As indicated at 806, either a true CAM or a CAM-equivalent, depending on which type is being used, is looked up against the input unit and current state. In either case, the rows of the state transition table of the FSM are such that each row contains the input, current state and corresponding next state for a transition. If a true CAM is used to implement the FSM, then at 808 the current input value is provided to the string dictionary and at 810, a matching operation is by looking up the concatenation of the current input unit and the current state of the FSM in the CAM to determine if a row with this combination is present in the FSM transition table. If such a row is detected at 812, the corresponding next state is determined and becomes the next state at 814. If the next state is an accepting state at 816, then a match signal is issued at 818, otherwise, a determination is made at 820 if there is a next input unit. If at 820 it is determined that there is an available next input unit, then the control is passed back to 804 using the next input unit. On the other hand, if at 820 it is determined that there is not a next input unit, then the process 800 is said to be completed and a no match signal is issued at 822. Returning back to 812 if no entry is found corresponding to the current input unit and current state, a default transition from the current state (as specified in the FSM) is performed at 824 and control is passed to 820 for determination if there is another input unit.

Returning to 806, if the FSM is implemented using a CAM-equivalent architecture, then at 826, the concatenation of the current input unit and current state is k-way hashed into k addresses, for example, in rows and columns. It is determined at 828 if there is a subset of the k addresses that contain information that identifies an address in a corresponding to a dictionary entry. The lookup is determined to be successful at 830 when the one of the subset of the k addresses identified in the string dictionary contains the same input unit and state pair as being currently applied at which point a row-match signal is issued at 832 otherwise at 834 a no row-match signal is issued. In either case, control is subsequently passed back to 812.

By using the CAM/CAM-equivalent architecture for implementing the string-matching automaton, the invention is able to achieve the ideal O(n) complexity of the Aho-Corasick algorithm for matching against the entire dictionary consisting of strings of arbitrary length. Furthermore, the invention provides the ability to advance the input stream by more than one character for reducing the complexity below O(n) in a manner that is superior to the Boyer-Moore algorithm that is restricted to matching against single strings. The CAM/CAM-equivalent lookup architecture allows the inventive string matching to overcome this limitation. The greatest benefit in the Boyer-Moore algorithm comes from the ability to advance the input stream by a large count when the last character does not occur in the dictionary string. With the inventive string matching engine, the pre-determined set of characters to look up to enable a Boyer-Moore-like jump, as well as the actual value of the jump, are stored in the CAM/CAM-equivalent lookup table. For example, all characters up to a certain distance from the end of the dictionary strings could be stored in the lookup table. Using the CAM/CAM-equivalent scheme, it is possible to determine in a single step whether the last character of the input stream segment matches any of these stored characters. If not, the stream is allowed to advance by the predetermined Boyer-Moore increment. This is a substantial performance boost since the lookup of the last character is performed in O(1) time for the entire set of dictionary strings. This scheme is further advanced by storing character sequences rather than single characters in the lookup table for computing the input stream increment. This increases the likelihood that the lookup returns a “no match”, thus making the use of the input stream increment more frequent.

Embodiments of the invention, including the apparatus disclosed herein, can be implemented in digital electronic circuitry, or in computer hardware, firmware, software, or in combinations of them. Apparatus embodiments of the invention can be implemented in a computer program product tangibly embodied in a machine-readable storage device for execution by a programmable processor; and method steps of the invention can be performed by a programmable processor executing a program of instructions to perform functions of the invention by operating on input data and generating output. Embodiments of the invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language.

Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits).

A number of implementations of the invention have been described. Nevertheless, it will be understood that various modifications may be made without departing from the spirit and scope of the invention. Accordingly, other embodiments are within the scope of the following claims.

What is claimed is:

1. Implementation of an arbitrary finite state machine (FSM), comprising:
performing an FSM transition by looking up a concatenation of the input and current state as an input look up value in the CAM or CAM-equivalent data structure; and
transitioning to the next state stored in the row and performing actions associated with the transition attributes stored in the row if the concatenation of the input and current state is found in the row, or performing a default transition from the current state if the concatenation of the input and current state is not found in the row, wherein the FSM is configured as either a content addressable memory (CAM) or CAM-equivalent data structure each having transition edges stored as rows, wherein each row includes the current state, input and next state, and any other attribute associated with the transition.

2. Implementation of an arbitrary FSM as recited in claim 1 if the CAM-equivalent data structure is provided, then
k-way hashing the lookup value into a first memory,
identifying only those of the k addresses in the first memory having an entry associated with some value stored in the CAM-equivalent data structure,
using the identified entries to determine if the input lookup value is stored in the CAM-equivalent data structure, and,
using the said identified entries to obtain additional attributes stored in association with the input lookup value if the input lookup value is found to be stored in the CAM-equivalent data structure, otherwise
performing the default transition.

3. Implementation of an arbitrary FSM as recited in claim 2 wherein the first memory consists of multiple bits comprising:
one or more Bloom bits that indicate absence of the input lookup value in the CAM-equivalent data structure if these bits are zero for any of the k hashes of the input lookup value;
a unique bit that indicates that the associated row in the first memory stores data associated with a value stored in the CAM-equivalent data structure; and
a plurality of bits that store data associated with a value stored in the CAM-equivalent data structure.

4. Implementation of an arbitrary FSM as recited in claim 3 wherein said plurality of bits that store data associated with values stored in the CAM-equivalent comprise a lookup value stored in the CAM, and other values associated said lookup value.

5. Implementation of an arbitrary FSM as recited in claim 3 wherein said plurality of bits that store data associated with said values stored in the CAM-equivalent comprise an address into a second memory that stores a second lookup value.

6. Implementation of an arbitrary FSM as recited in claim 1, wherein the CAM is an integrated circuit device.

7. Implementation of an arbitrary FSM as recited in claim 1, further comprising:
arbitrary-length string matching comprising:
configuring a string dictionary as the finite state machine with accepting states identifying dictionary strings,
performing string matching by traversing the FSM in response to the values constituting the string,
performing said traversal using CAM-based FSM implementation, and
identifying a string as being matched when a corresponding accepted FSM state is reached.

8. Implementation of an arbitrary FSM as recited in claim 7, wherein a string entry is added or deleted by updating appropriate transition edges in the CAM or CAM equivalent data structure.

9. Implementation of FSM-based arbitrary string matching as recited in claim 8, wherein the representation of the string dictionary as an FSM is performed using the Aho-Corasick algorithm.

10. Computer program product executable by a processor for implementing an arbitrary finite state machine (FSM), comprising:
computer code for performing an FSM transition by looking up a concatenation of the input and current state as an input look up value in the CAM or CAM-equivalent data structure;
computer code for transitioning to the next state stored in the row and performing actions associated with the transition attributes stored in the row if the concatenation of the input and current state is found in the row, or performing a default transition from the current state if the concatenation of the input and current state is not found in the row, wherein the FSM is configured as either a content addressable memory (CAM) or CAM-equivalent data structure each having transition edges stored as rows, wherein each row includes the current state, input and next state, and any other attribute associated with the transition; and
computer readable medium for storing the computer code.

11. Computer program product as recited in claim 10, further comprising:
computer code for k-way hashing the lookup value into a first memory,
computer code for identifying only those of the k addresses in the first memory having an entry associated with some value stored in the CAM-equivalent data structure,
computer code for using the identified entries to determine if the input lookup value is stored in the CAM-equivalent data structure, and,
computer code for using the said identified entries to obtain additional attributes stored in association with the input lookup value if the input lookup value is found to be stored in the CAM-equivalent data structure, otherwise performing the default transition.

12. Computer program product as recited in claim 11, wherein the CAM is incorporated into an integrated circuit coupled to the processor.

13. Computer program product as recited in claim 11 wherein the first memory includes multiple bits comprising:
one or more Bloom bits that indicate absence of the input lookup value in the CAM-equivalent data structure if these bits are zero for any of the k hashes of the input lookup value; and
a unique bit that indicates that the associated row in the first memory stores data associated with a value stored in the CAM-equivalent data structure.

14. Computer program product as recited in claim 13, wherein the multiple bits further comprises:
a unique bit that indicates that the associated row in the first memory stores data associated with a value stored in the CAM-equivalent data structure.

15. Computer program product as recited in claim 13, wherein the multiple bits further comprises:
a plurality of bits that store data associated with a value stored in the CAM-equivalent data structure.

16. Computer program product as recited in claim 15 wherein said plurality of bits that store data associated with values stored in the CAM-equivalent comprise a lookup value stored in the CAM, and other values associated said lookup value.

17. Computer program product as recited in claim 10, further comprising:
computer code for arbitrary-length string matching comprising:
computer code for configuring a string dictionary as the finite state machine with accepting states identifying dictionary strings,
computer code for performing string matching by traversing the FSM in response to the values constituting the string,
computer code for performing said traversal using CAM-based FSM implementation, and
computer code for identifying a string as being matched when a corresponding accepted FSM state is reached.

18. Computer program product as recited in claim 10, wherein a string entry is added or deleted by updating appropriate transition edges in the CAM or CAM equivalent data structure.

19. A method of arbitrary length string matching using a string dictionary represented as a finite state machine in which a state represents the past history of a received input string unit, comprising:
receiving an arbitrary length string formed of a plurality of string units;
selecting a number of the plurality of string units as input string units;
concatenating the input string unit with a current state of the FSM as an input value;
detecting if a row in a state transition table of the FSM includes the input value;
determining a corresponding next state if a row that includes the input value is detected; and
transitioning to the next state.

20. A method as recited in claim 19, wherein each row contains a corresponding input value, a current state and corresponding next state for a transition.

21. A method as recited in claim 20, wherein a transition from one state to the next is predicated on the value of the current input character of the string.

22. A method as recited in claim 19, wherein the FSM is stored in a Content Addressable Memory (CAM).

23. A method as recited in claim 22, wherein the CAM stores the rows of the state transition table of the FSM such that each row contains the input, current state and corresponding next state for a transition.

24. A method as recited in claim 23, wherein some states of the FSM are marked accepting states such that when one of these states is reached, a specific string is known to have been matched wherein the accepting state information is also stored with the state transition rows in the CAM.

25. A method as recited in claim 19 wherein the arbitrary length string being matched is received one or more input units at a time.

26. A method as recited in claim 25, wherein if no entry in the CAM is found corresponding to the input value, then performing a default transition from the current state as specified by default transition instructions stored in the FSM and then performing edge look-up operation according to the combination of the default state and the current input.

27. Computer program product for arbitrary length string matching using a string dictionary represented as a finite state machine in which a state represents the past history of a received input string unit, comprising:
computer code for receiving an arbitrary length string formed of a plurality of string units;
computer code for selecting a number of the plurality of string units as input string units;
computer code for concatenating the input string unit with a current state of the FSM as an input value;
computer code for detecting if a row in a state transition table of the FSM includes the input value;
computer code for determining a corresponding next state if a row that includes the input value is detected;
computer code for transitioning to the next state; and
computer readable medium for storing the computer code.

28. Computer program product as recited in claim 27, wherein each row contains a corresponding input value, a current state and corresponding next state for a transition.

29. Computer program product as recited in claim 28, wherein a transition from one state to the next is predicated on the value of the current input character of the string.

30. Computer program product as recited in claim 27, wherein the FSM is stored in a Content Addressable Memory (CAM).

31. Computer program product as recited in claim 28, wherein the CAM stores the rows of the state transition table of the FSM such that each row contains the input, current state and corresponding next state for a transition.

32. Computer program product as recited in claim 31, wherein some states of the FSM are marked accepting states such that when one of these states is reached, a specific string is known to have been matched wherein the accepting state information is also stored with the state transition rows in the CAM.

33. A method as recited in claim 27 wherein the arbitrary length string being matched is received one or more input units at a time.

34. A method as recited in claim 32, wherein if no entry in the CAM is found corresponding to the input value, then performing a default transition from the current state as specified by default transition instructions stored in the FSM.

35. An apparatus for implementing an arbitrary finite state machine (FSM), comprising:
means for providing a true content addressable memory (CAM) or CAM-equivalent data structure having transition edges stored as rows in the CAM or CAM-equivalent data structure, wherein each row includes the current state, input and next state, and any other attribute associated with the transition;
means for performing an FSM transition by looking up a concatenation of the input and current state as an input look up value in the CAM or CAM-equivalent data structure; and
means for transitioning to the next state stored in the row and performing actions associated with the transition attributes stored in the row if the concatenation of the input and current state is found in the row, or performing a default transition from the current state if the concatenation of the input and current state is not found in the row.

36. An apparatus as recited in claim 35 if the CAM-equivalent data structure is provided, then
means for k-way hashing the lookup value into a first memory,
means for identifying only those of the k addresses in the first memory having an entry associated with some value stored in the CAM-equivalent data structure,
means for using the identified entries to determine if the input lookup value is stored in the CAM-equivalent data structure, and,
means for using the said identified entries to obtain additional attributes stored in association with the input lookup value if the input lookup value is found to be stored in the CAM-equivalent data structure.

37. An apparatus as recited in claim 35 if the true CAM is provided, then
means for determining if the lookup values in any of the identified k addresses in the true CAM is the same as the applied lookup value; and
means for deeming the input lookup value to exist in the true CAM and identifying the additional values stored at the row as output for appropriate processing if such a row is found in the true CAM.

38. An apparatus as recited in claim 36 wherein the first memory consists of multiple bits comprising:
one or more Bloom bits that indicate absence of the input lookup value in the CAM-equivalent data structure if these bits are zero for any of the k hashes of the input lookup value;
a unique bit that indicates that the associated row in the first memory stores data associated with a value stored in the CAM-equivalent data structure; and
a plurality of bits that store data associated with a value stored in the CAM-equivalent data structure.

39. An apparatus as recited in claim 38 wherein said plurality of bits that store data associated with values stored in the CAM-equivalent comprise a lookup value stored in the CAM, and other values associated said lookup value.

40. An apparatus as recited in claim 39, further comprising:
means for arbitrary-length string matching further comprising:
means for configuring a string dictionary as the finite state machine with accepting states identifying dictionary strings,
means for performing string matching by traversing the FSM in response to the values constituting the string,
means for performing said traversal using CAM-based FSM implementation, and
means for identifying a string as being matched when a corresponding accepted FSM state is reached.

41. An apparatus as recited in claim 35, wherein a string entry is added or deleted by updating appropriate transition edges in the CAM or CAM equivalent data structure.

42. An apparatus for arbitrary length string matching using a string dictionary represented as a finite state machine in which a state represents the past history of a received input string unit, comprising:
means for receiving an arbitrary length string formed of a plurality of string units;
means for selecting a number of the plurality of string units as input string units;
means for concatenating the input string unit with a current state of the FSM as an input value;
means for detecting if a row in a state transition table of the FSM includes the input value;
means for determining a corresponding next state if a row that includes the input value is detected; and
means for transitioning to the next state.

43. An apparatus as recited in claim 42, wherein each row contains a corresponding input value, a current state and corresponding next state for a transition.

44. An apparatus as recited in claim 43, wherein a transition from one state to the next is predicated on the value of the current input character of the string.

45. An apparatus as recited in claim 44, wherein the FSM is stored in a Content Addressable Memory (CAM).

46. An apparatus as recited in claim 45, wherein the CAM stores the rows of the state transition table of the FSM such that each row contains the input, current state and corresponding next state for a transition.

47. An apparatus as recited in claim 46, wherein some states of the FSM are marked accepting states such that when one of these states is reached, a specific string is known to have been matched wherein the accepting state information is also stored with the state transition rows in the CAM.

48. An apparatus as recited in claim 47 wherein the arbitrary length string being matched is received one or more input units at a time.

49. An apparatus as recited in claim 48, wherein if no entry in the CAM is found corresponding to the input value, then performing a default transition from the current state as specified by default transition instructions stored in the FSM.
